(19) United States
(12) Patent Application Publication
(10) Pub. No.: US 2020/0298768 A1
(43) Pub. Date: Sep. 24, 2020

(54) RECONFIGURABLE RACK

(71) Applicant: GM Global Technology Operations LLC, Detroit, MI (US)

(72) Inventors: Thomas P. Grabowski, Shelby Township, MI (US); Mark Pulleyblank, Harrison Township, MI (US)

(21) Appl. No.: 16/361,610

(22) Filed: Mar. 22, 2019

(51) Int. Cl. B60R 9/045; B60R 9/058; B60P 3/42

(52) U.S. Cl. CPC B60R 9/045; B60P 3/42; B60R 9/058

(57) ABSTRACT

A reconfigurable rack for a motor vehicle having a cabin and a bed includes a first tube with a first section, a second section and a third section, a second tube with a first section, a second section and a third section. The first sections are generally parallel to a floor of the bed, and the second and third sections of the respective tube attach the tube to a first side and a second side of the bed. The third tube has a first position located proximal to the first tube and the second tube, with the second section and the third section of the third tube angled towards the first tube, the second tube and the cabin. The third tube has a second position located distal to the first tube and the second tube towards the rear of the bed.

The present disclosure relates to a rack for a motor vehicle. More particularly, the present disclosure relates to a reconfigurable rack.

Certain motor vehicles, such as trucks, are utilized as utility or work vehicles, while other trucks are utilized for sports purposes. Some utility vehicles such as pickup trucks have racks mounted in the bed of the truck that provide a platform for objects such as ladders or construction materials. Such pickup trucks, however, are not particularly accommodating for sports purposes.

Thus, while current pickup truck racks achieve their intended purpose, there is a need for a new and improved type of pickup truck racks.

### SUMMARY

According to several aspects, a reconfigurable rack for a motor vehicle having a cabin and a bed includes a first tube having a first section positioned generally parallel to a floor of the bed, a second section that extends from the first section and attaches to a first side of the bed, and a third section that extends from the first section and attaches to a second side of the bed, the first side and the second side of the bed being generally parallel; a second tube having a first section positioned generally parallel to the floor of the bed, a second section that extends from the first section and attaches to the first side of the bed, and a third section that extends from the first section and attaches to the second side of the bed, the second section and the third section of the second tube being angled towards the first tube and the cabin; and a third tube having a first section positioned generally parallel to the floor of the bed, a second section that extends from the first section and attaches to the first side of the bed, and a third section that extends from the first section and attaches to the second side of the bed, the second tube being located between the first tube and the third tube, the third tube having a first position located proximal to the first tube and the second tube, the second section and the third section of the third tube being angled towards the first tube, the second tube and the cabin when the third tube is in the first position, the third tube having a second position located distal to the first tube and the second tube towards the rear of the bed, the first section and the second section of the third tube being generally parallel to the first section and the second section of the first tube when the third tube is in the second position.

In an additional aspect of the present disclosure, the rack further includes a fourth tube with a first position, a height of the fourth tube from the floor of the bed in the first position being substantially equal to a height of the first section of the third tube from the floor when the third tube is in the second position.

In another aspect of the present disclosure, the fourth tube has a second position, the height of the fourth tube from the floor of the bed in the second position being substantially equal to a height of the first section of the first tube, a height of the first section of the second tube and the height of the first section of the third tube from the floor of the bed when the third tube is in the first position.

In another aspect of the present disclosure, the rack further includes a first cross tube and a second cross tube spaced apart from the first cross tube, the first cross tube and the second cross tube connecting the first tube and the second tube.

In another aspect of the present disclosure, a first end of the fourth tube is connected to the first cross tube and a second end of the fourth tube is connected to the second cross tube.

In another aspect of the present disclosure, the fourth tube pivots at the connections to the first cross tube and the second cross tube between the first position and the second position of the fourth tube.

In another aspect of the present disclosure, the rack further includes a first cross tube and a second cross tube spaced apart from the first cross tube, the first cross tube and the second cross tube connecting the second tube and the third tube when the third tube is in the first position.

In another aspect of the present disclosure, the rack further includes a first docking handle that attaches the second section of the third tube to the first side of the bed and a second docking handle that attaches the third section of the third tube to the second side of the bed when the third tube is in the second position.

In another aspect of the present disclosure, each docking handle includes a push-pull pin mechanism with a first position and a second position, when in the first position the push-pull mechanism attaching the docking handle to a projection extending from the respective side of the bed to secure the docking handle to the side of the bed.

In another aspect of the present disclosure, the push-pull mechanism in the first position attaches the respective section of the third tube to the respective docking handle.

In another aspect of the present disclosure, the push-pull mechanism in the second position releases the respective section from the respective docking handle.

According to several aspects, a reconfigurable rack for a motor vehicle having a cabin and a bed includes a first tube having a first section positioned generally parallel to the a floor of the bed, a second section that extends from the first section and attaches to a first side of the bed, and a third section that extends from the first section and attaches to a second side of the bed, the first side and the second side of the bed being generally parallel; a second tube having a first section positioned generally parallel to the floor of the bed, a second section that extends from the first section and attaches to the first side of the bed, and a third section that extends from the first section and attaches to the second side of the bed, the second section and the third section of the second tube being angled towards the first tube and the cabin; a third tube having a first section positioned generally parallel to the floor of the bed, a second section that extends from the first section and attaches to the first side of the bed, and a third section that extends from the first section and attaches to the second side of the bed, the second tube being located between the first tube and the third tube, the third tube having a first position located proximal to the first tube and the second tube, the second section and the third section of the third tube being angled towards the first tube, the second tube and the cabin when the third tube is in the first position, the third tube having a second position located distal to the first tube and the second tube towards the rear of the bed, the first section and the second section of the third tube being generally parallel to the first section and the second section of the first tube when the third tube is in the second position; and a fourth tube with a first position and a second position, a height of the fourth tube from the floor of the bed in the first position being substantially equal to a height of the first section of the third tube from the floor when the third tube is in the second position, the height of the fourth tube from the floor of the bed in the second position being substantially equal to a height of the first section of the first tube, a height of the first section of the second tube and the height of the first section of the third tube from the floor of the bed when the third tube is in the first position.

In another aspect of the present disclosure, the rack further includes a first cross tube and a second cross tube spaced apart from the first cross tube, the first cross tube and the second cross tube connecting the first tube and the second tube, a first end of the fourth tube being connected to the first cross tube and a second end of the fourth tube being connected to the second cross tube, and the fourth tube pivoting at the connections to the first cross tube and the second cross tube between the first position and the second position of the fourth tube.

According to several aspects, a motor vehicle includes a cabin; a bed with a floor, a first side and a second side; and a reconfigurable rack. The reconfigurable rack includes a first tube having a first section positioned generally parallel to the floor of the bed, a second section that extends from the first section and attaches to the first side of the bed, and a third section that extends from the first section and attaches to the second side of the bed, the first side and the second side of the bed being generally parallel; a second tube having a first section positioned generally parallel to the floor of the bed, a second section that extends from the first section and attaches to the first side of the bed, and a third section that extends from the first section and attaches to the second side of the bed, the second section and the third section of the second tube being angled towards the first tube and the cabin; and a third tube having a first section positioned generally parallel to the floor of the bed, a second section that extends from the first section and attaches to the first side of the bed, and a third section that extends from the first section and attaches to the second side of the bed, the second tube being located between the first tube and the third tube, the third tube having a first position located proximal to the first tube and the second tube, the second section and the third section of the third tube being angled towards the first tube, the second tube and the cabin when the third tube is in the first position, the third tube having a second position located distal to the first tube and the second tube towards the rear of the bed, the first section and the second section of the third tube being generally parallel to the first section and the second section of the first tube when the third tube is in the second position.

In another aspect of the present disclosure, the motor vehicle further includes a fourth tube with a first position, a height of the fourth tube from the floor of the bed in the first position being substantially equal to a height of the first section of the third tube from the floor when the third tube is in the second position.

In another aspect of the present disclosure, the fourth tube has a second position, the height of the fourth tube from the floor of the bed in the second position being substantially equal to a height of the first section of the first tube, a height of the first section of the second tube and the height of the first section of the third tube from the floor of the bed when the third tube is in the first position.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A is a perspective view of a reconfigurable rack in one position according to an exemplary embodiment;

FIG. 1B is perspective view of the reconfigurable rack in another position;

FIG. 2 is a rear perspective view of the reconfigurable rack shown in FIG. 2;

FIG. 3 is a perspective view of a docking handle for the reconfigurable rack according to an exemplary embodiment;

FIG. 4A is a side cross-sectional view of the docking handle in a locked position according to an exemplary embodiment; and

FIG. 4B is a side cross-sectional view of the docking handle in an unlocked position according to an exemplary embodiment.

### DETAILED DESCRIPTION

The following description is merely exemplary in nature and is not intended to limit the present disclosure, application, or uses.

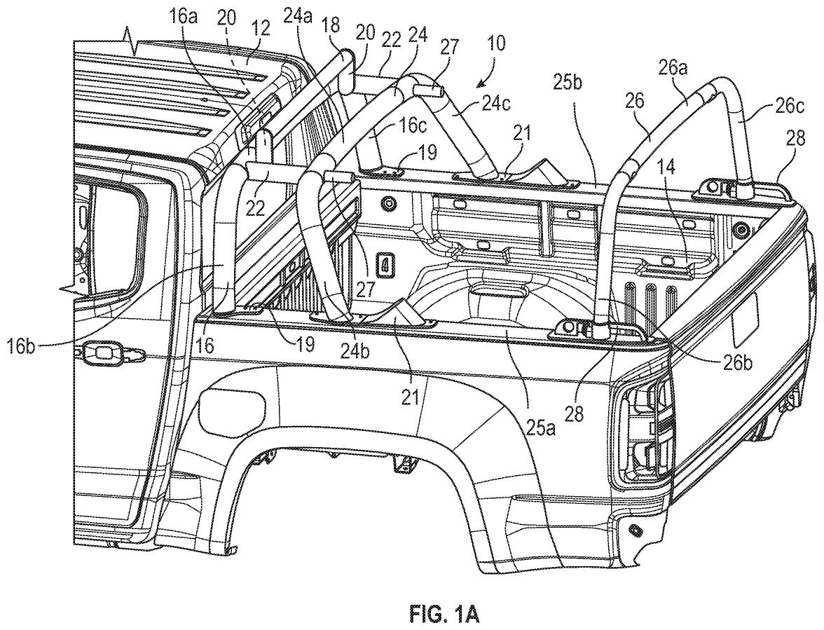

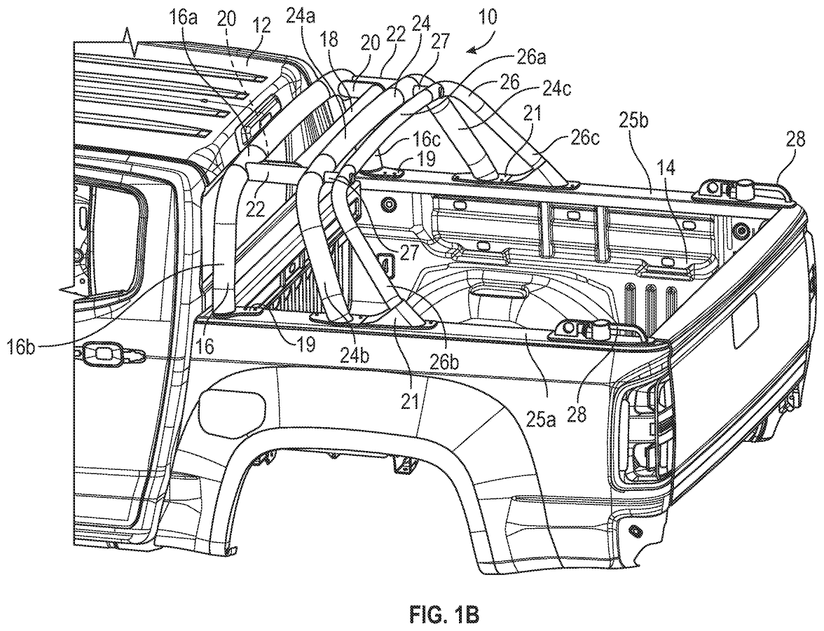

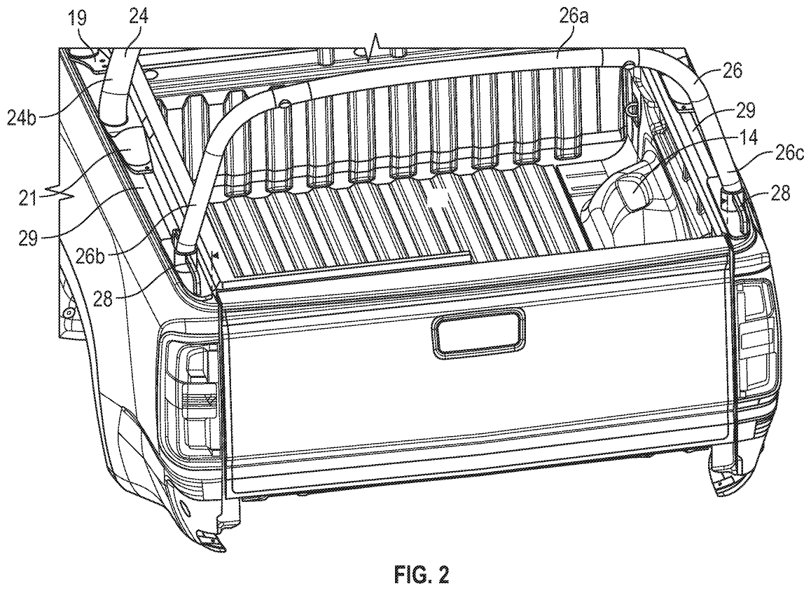

Referring now to FIGS. 1A and 1B, there is shown a reconfigurable rack 10 for a motor vehicle, such as a pickup truck with a cabin 12 and a bed 14. The reconfigurable rack 10 includes a first tube 16, a second tube 24, a third tube 26 and a fourth tube 18. FIG. 1B shows the reconfigurable rack 10 in a first position, and FIG. 1A shows the reconfigurable rack 10 in a second position

The first tube 16 has a first section 16a positioned generally parallel to a floor of the bed 14, a second section 16b that extends from the first section 16a and attaches to a first side 25a of the bed 14, and a third section 16c that extends from the first section 16a and attaches to a second side 25b of the bed. One of a pair of attachment mechanisms 19 secures the second section 16b to the first side 25a, and the other attachment mechanism secures the third section to the second side 25b. The first side 25a and the second side 25b of the bed 14 are generally parallel.

The second tube 24 has a first section 24a positioned generally parallel to the floor of the bed 14, a second section 24b that extends from the first section 24a and attaches to the first side 25a of the bed 14 with one of a pair of attachment mechanisms 21, and a third section 24c that extends from the first section 24a and attaches to the second side 25b of the bed 14 with the other attachment mechanism 21. The second section 24b and the third section 24c of the second tube 24 are angled towards the first tube 16 and the cabin 12. A pair of cross tubes 22 that are spaced apart connect the first tube 16 and the second tube 24 together.

The third tube 26 has a first section 26a positioned generally parallel to the floor of the bed 14, a second section 26b that extends from the first section 26a and removably attaches to the first side 25a of the bed 14 with one of a pair of docking handles 28 in the second position (FIG. 1A), and a third section 26c that extends from the first section 26a and removably attaches to the second side 25b of the bed 14 with the other docking handle 28. In the reconfigurable rack's second position, the third tube 26 is located distal to the first tube 16 and the second tube 24 towards the rear of the bed 14 with the second tube 24 positioned between the first tube 16 and the third tube 26. The first section 26b and the second section 26c of the third tube 26 are generally parallel to the first section 16b and the second section 16c of the first tube 16 when the third tube 26 is in the second position.

When the reconfigurable rack 10 is in the first position (FIG. 1B), the second section 26b of the third tube 26 is removably attached to one of the attachment mechanisms 21, and the third section 26c of the third tube is removably attached to the other attachment mechanism 21. Further, the second section 26b and the third section 26c of the third tube 26 are angled towards the first tube 16, the second tube 24 and the cabin 12. Further, a pair of cross tubes 27 that are spaced apart connect the third tube 26 and the second tube 24 together in the first position.

The fourth tube 18 is generally parallel to the floor of the bed 14, and the ends of fourth tube 18 attach to the respective cross tubes 22 with respective connectors 20, enabling the fourth tube 18 to pivot about the connection between the connectors 20 and the cross tubes 22. The fourth tube 18 has a first position in which it is pivoted upwards (FIG. 1A) and a second position in which it is pivoted downwards (FIG. 1B). Note that the first position and the second position of the fourth tube 18 does not necessarily coincide with the first position and the second position of the reconfigurable rack 10. The height of the fourth tube 18 from the floor of the bed in its first position substantially equal to a height of the first section 26a of the third tube 26 from the floor when the third tube is in the second position of the reconfigurable rack 10. When the fourth tube 18 is in its second position, the height of the fourth tube 18 from the floor of the bed 14 is substantially equal to the height of the first section 16a of the first tube 16, the height of the first section 24a of the second tube 24 and the height of the first section 26a of the third tube 26 from the floor of the bed 14 when the reconfigurable rack 10 is in the first position (FIG. 1B).

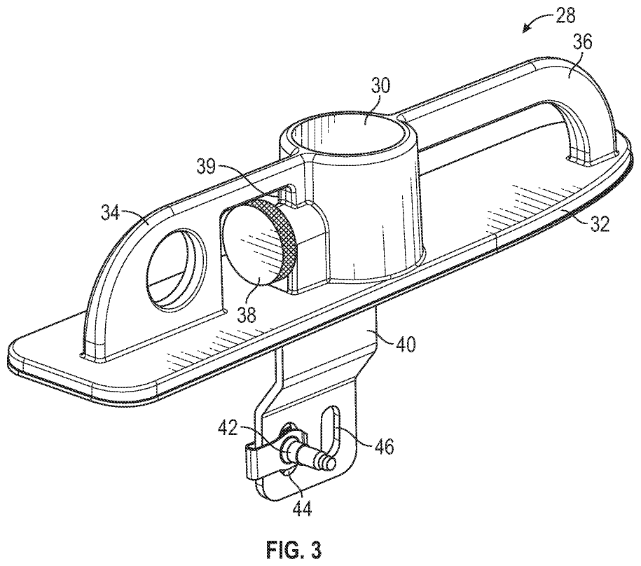

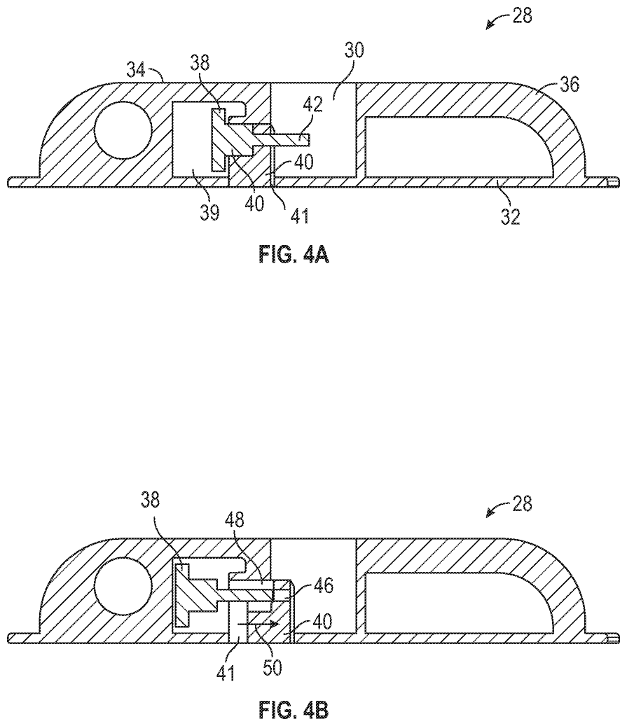

Referring further to FIGS. 3, 4A and 4B, details of the docking handles 28 are shown. As described previously, the docking handles attach the third tube 26 to the first side 25a and the second side 25b of the bed 14 towards the rear of the bed 14 with the reconfigurable rack 10 is in the second position.

Each docking handle 28 includes a plate 32 that rests on the respective sides 25a, 25b of the bed 14. The docking handle 28 further includes handle portions 34 and 36 that enable a user to grasp the docking handle 28. Positioned between the handle portions 34 and 36 is an opening 30 into which the ends of the respective sections 26b, 26c of the third tube 26 are placed.

A push-pull pin mechanism 38 positioned in an opening 39 is utilized to secure the docking handle 28 to the bed 14 with an extension 40 and the third tube 26 to the docking handles 28. The extension 40 is secured to the bed 14 with a screw, pin or rivet 42 that extends through one of two openings 44, 46. To attach the docking handle 28 to the respective side of the bed 14, the docking handle 28 is placed over the extension 40 such that the extension 40 extends into an opening 41 of the docking handle 28. The docking handle is pushed in the direction 50 (FIG. 4B) to secure the docking handle 28 to the extension 40 with the push pull mechanism 38. The push pull mechanism 38 is pushed in further in the direction 50 to secure the respective ends of the second section 26b and the third section 26c of the third tube to the docking handles 28. Reversing the procedure releases the third tube 26 from the docking handles 28 and the docking handles 28 from the bed 14.

A reconfigurable rack of the present disclosure offers several advantages. These include, but are not limited to, enabling a user to utilize the motor vehicle in various configurations. For example, when the reconfigurable rack 10 is in the second position, the vehicle can be employed to transport, for example, a ladder and/or panels or a surfboard on top of the reconfigurable rack 10. And when the reconfigurable rack 10 is in the first position, objects in the bed 14 can rest on top of the reconfigurable rack 10. Further, the reconfigurable rack 10 in the first position provides a sportier appearance to the vehicle.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A reconfigurable rack for a motor vehicle having a cabin and a bed, the rack comprising:
a first tube having a first section positioned generally parallel to a floor of the bed, a second section that extends from the first section and attaches to a first side of the bed, and a third section that extends from the first section and attaches to a second side of the bed, the first side and the second side of the bed being generally parallel;
a second tube having a first section positioned generally parallel to the floor of the bed, a second section that extends from the first section and attaches to the first side of the bed, and a third section that extends from the first section and attaches to the second side of the bed, the second section and the third section of the second tube being angled towards the first tube and the cabin; and
a third tube having a first section positioned generally parallel to the floor of the bed, a second section that extends from the first section and attaches to the first side of the bed, and a third section that extends from the first section and attaches to the second side of the bed, the second tube being located between the first tube and the third tube, the third tube having a first position located proximal to the first tube and the second tube, the second section and the third section of the third tube being angled towards the first tube, the second tube and the cabin when the third tube is in the first position, the third tube having a second position located distal to the first tube and the second tube towards a rear of the bed, the first section and the second section of the third tube being generally parallel to the first section and the second section of the first tube when the third tube is in the second position.

2. The rack of claim 1 furthering comprising a fourth tube with a first position, a height of the fourth tube from the floor of the bed in the first position being substantially equal to a height of the first section of the third tube from the floor when the third tube is in the second position.

3. The rack of claim 2 wherein the fourth tube has a second position, the height of the fourth tube from the floor of the bed in the second position being substantially equal to a height of the first section of the first tube, a height of the first section of the second tube and the height of the first section of the third tube from the floor of the bed when the third tube is in the first position.

4. The rack of claim 3 further comprising a first cross tube and a second cross tube spaced apart from the first cross tube, the first cross tube and the second cross tube connecting the first tube and the second tube.

5. The rack of claim 4 wherein a first end of the fourth tube is connected to the first cross tube and a second end of the fourth tube is connected to the second cross tube.

6. The rack of claim 5 wherein the fourth tube pivots at the connections to the first cross tube and the second cross tube between the first position and the second position of the fourth tube.

7. The rack of claim 1 further comprising a first cross tube and a second cross tube spaced apart from the first cross tube, the first cross tube and the second cross tube connecting the second tube and the third tube when the third tube is in the first position.

8. The rack of claim 1 further comprising a first docking handle that attaches the second section of the third tube to the first side of the bed and a second docking handle that attaches the third section of the third tube to the second side of the bed when the third tube is in the second position.

9. The rack of claim 8 wherein each docking handle includes a push-pull pin mechanism with a first position and a second position, when in the first position the push-pull mechanism attaching the docking handle to a projection extending from the respective side of the bed to secure the docking handle to the side of the bed.

10. The rack of claim 9 wherein the push-pull mechanism in the first position attaches the respective section of the third tube to the respective docking handle.

11. The rack of claim 10 wherein the push-pull mechanism in the second position releases the respective section from the respective docking handle.

12. A reconfigurable rack for a motor vehicle having a cabin and a bed, the rack comprising:
a first tube having a first section positioned generally parallel to a floor of the bed, a second section that extends from the first section and attaches to a first side of the bed, and a third section that extends from the first section and attaches to a second side of the bed, the first side and the second side of the bed being generally parallel;
a second tube having a first section positioned generally parallel to the floor of the bed, a second section that extends from the first section and attaches to the first side of the bed, and a third section that extends from the first section and attaches to the second side of the bed, the second section and the third section of the second tube being angled towards the first tube and the cabin;
a third tube having a first section positioned generally parallel to the floor of the bed, a second section that extends from the first section and attaches to the first side of the bed, and a third section that extends from the first section and attaches to the second side of the bed, the second tube being located between the first tube and the third tube, the third tube having a first position located proximal to the first tube and the second tube, the second section and the third section of the third tube being angled towards the first tube, the second tube and the cabin when the third tube is in the first position, the third tube having a second position located distal to the first tube and the second tube towards the rear of the bed, the first section and the second section of the third tube being generally parallel to the first section and the second section of the first tube when the third tube is in the second position; and
a fourth tube with a first position and a second position, a height of the fourth tube from the floor of the bed in the first position being substantially equal to a height of the first section of the third tube from the floor when the third tube is in the second position, the height of the fourth tube from the floor of the bed in the second position being substantially equal to a height of the first section of the first tube, a height of the first section of the second tube and the height of the first section of the third tube from the floor of the bed when the third tube is in the first position.

13. The rack of claim 12 further comprising a first cross tube and a second cross tube spaced apart from the first cross tube, the first cross tube and the second cross tube connecting the first tube and the second tube, wherein a first end of the fourth tube is connected to the first cross tube and a second end of the fourth tube is connected to the second cross tube, and wherein the fourth tube pivots at the connections to the first cross tube and the second cross tube between the first position and the second position of the fourth tube.

14. The rack of claim 12 further comprising a first docking handle that attaches the second section of the third tube to the first side of the bed and a second docking handle that attaches the third section of the third tube to the second side of the bed when the third tube is in the second position.

15. The rack of claim 14 wherein each docking handle includes a push-pull pin mechanism with a first position and a second position, when in the first position the push-pull mechanism attaching the docking handle to a projection extending from the respective side of the bed to secure the docking handle to the side of the bed.

16. The rack of claim 15 wherein the push-pull mechanism in the first position attaches the respective section of the third tube to the respective docking handle.

17. The rack of claim 16 wherein the push-pull mechanism in the second position releases the respective section from the respective docking handle.

18. A motor vehicle comprising:
a cabin;
a bed with a floor, a first side and a second side; and
a reconfigurable rack including:
a first tube having a first section positioned generally parallel to the floor of the bed, a second section that extends from the first section and attaches to the first side of the bed, and a third section that extends from the first section and attaches to the second side of the bed, the first side and the second side of the bed being generally parallel;
a second tube having a first section positioned generally parallel to the floor of the bed, a second section that extends from the first section and attaches to the first side of the bed, and a third section that extends from the first section and attaches to the second side of the bed, the second section and the third section of the second tube being angled towards the first tube and the cabin; and
a third tube having a first section positioned generally parallel to the floor of the bed, a second section that extends from the first section and attaches to the first side of the bed, and a third section that extends from the first section and attaches to the second side of the bed, the second tube being located between the first tube and the third tube, the third tube having a first position located proximal to the first tube and the second tube, the second section and the third section of the third tube being angled towards the first tube, the second tube and the cabin when the third tube is in the first position, the third tube having a second position located distal to the first tube and the second tube towards a rear of the bed, the first section and the second section of the third tube being generally parallel to the first section and the second section of the first tube when the third tube is in the second position.

19. The motor vehicle of claim 18 further comprising a fourth tube with a first position, a height of the fourth tube from the floor of the bed in the first position being substantially equal to a height of the first section of the third tube from the floor when the third tube is in the second position.

20. The motor vehicle of claim 19 wherein the fourth tube has a second position, the height of the fourth tube from the floor of the bed in the second position being substantially equal to a height of the first section of the first tube, a height of the first section of the second tube and the height of the first section of the third tube from the floor of the bed when the third tube is in the first position.
